(19) United States
(12) Patent Application Publication
(10) Pub. No.: US 2026/0356703 A1
(43) Pub. Date: Nov. 12, 2026

(54) PURE WATER PRODUCTION METHOD, PURE WATER PRODUCTION DEVICE, AND ULTRA-PURE WATER PRODUCTION SYSTEM

(71) Applicant: NOMURA MICRO SCIENCE CO., LTD., Kanagawa (JP)

(72) Inventors: Yukio NOGUCHI, Kanagawa (JP); Kengo YAMADA, Kanagawa (JP)

(73) Assignee: NOMURA MICRO SCIENCE CO., LTD., Kanagawa (JP)

(21) Appl. No.: 19/122,948

(22) PCT Filed: Oct. 20, 2023
(86) PCT No.: PCT/JP2023/038072

§ 371 Date: Apr. 21, 2025

(30) Foreign Application Priority Data
Oct. 26, 2022 (JP) 2022-171509

(51) Int. Cl. C02F 1/44; C02F 1/469; C02F 1/68; C02F 101/10

(52) U.S. Cl. CPC C02F 1/441; C02F 1/4695; C02F 1/68; C02F 2101/108; C02F 2201/007; C02F 2301/08

(57) ABSTRACT

Chemical usage is reduced by reducing the treatment load on three stages of reverse osmosis membrane devices on the preceding stage, enabling efficient production of pure water with reduced boron concentration. Provided is a pure water production method and device, wherein raw water is treated using at least three stages of ultra-low pressure reverse osmosis membrane devices. The method includes treating raw water with a first-stage reverse osmosis membrane device, obtaining alkaline water, treating the alkaline water with a second-stage reverse osmosis membrane device, and treating the permeate water with a third-stage reverse osmosis membrane device to obtain pure water having a boron concentration of 3-20 μg/L and an electric conductivity of 0.3-40 μS/cm. A negatively charged membrane with a cross-linked aromatic polyamide skin layer is used as a reverse osmosis membrane, and the raw water contains 1-100 mg/L of carbonic acid and ≤150 μg/L of boron.

### CROSS-REFERENCE TO RELATED APPLICATIONS

This application is a 35 U.S.C. § 371 national phase of PCT International Application No. PCT/JP2023/038072, filed Oct. 20, 2023, which claims the benefit of priority under 35 U.S.C. § 119 to Japanese Patent Application No. 2022-171509, filed Oct. 26, 2022, the contents of which are incorporated herein by reference in its entirety.

### FIELD

The present invention relates to a pure water production method and a pure water production device, capable of removing boron included in raw water to significantly reduce the boron concentration, and to an ultra-pure water production system capable of obtaining ultra-pure water with high water quality using the pure water production method and the pure water production device.

### BACKGROUND

As a method for producing pure water by treating raw water containing boron, a pure water production method in which a reverse osmosis membrane treatment is performed after the pH of raw water is adjusted to 9.2 or higher by adding an alkali thereto has been known. In this method, a non-regenerative type ion exchange device that does not perform chemical regeneration is disposed in a subsequent stage, and in order to reduce the load on the non-regenerative type ion exchange device, the specific resistance of treated water is also increased to, for example, 5.0 MΩ·cm by adding an acid to permeate water from which boron has been removed and further performing a reverse osmosis membrane treatment using a special reverse osmosis membrane called a positively charged reverse osmosis membrane device. In addition, since scale clogging due to hardness is likely to progress in a reverse osmosis membrane device that treats alkaline water to be treated, suppression of scale clogging is attempted by providing a hardness removal mechanism or a degassing device with a high decarboxylation capability in a preceding stage of the reverse osmosis membrane device (see, for example, Patent Literatures 1 and 2).

In addition, a method for producing, without performing decarboxylation using an acid, pure water with purity as high as 15 MΩ·cm by combining a membrane degassing device and three stages of reverse osmosis membrane devices, adding a scale inhibitor and an alkali to raw water, passing water through the reverse osmosis membrane device of the first stage, and using a reverse osmosis membrane that has a high salt rejection rate in a low salt concentration region as a reverse osmosis membrane of the reverse osmosis membrane device of the third stage has been also proposed (see, for example, Patent Literature 3).

### CITATION LIST

### Patent Literature

### Patent Literature 1

Japanese Patent Laid-Open No. 11-128921

### Patent Literature 2

Japanese Patent Laid-Open No. 11-128922

### Patent Literature 3

Japanese Patent Laid-Open No. 2000-061465

### SUMMARY

However, in the conventional pure water production methods described above, although the load of ion removal on a reverse osmosis membrane on the subsequent stage side is reduced, the load of ion removal on a plurality of reverse osmosis membranes on the preceding stage side is significantly high. For example, scale due to silica and fine particles are likely to attach to a positively charged reverse osmosis membrane that treats acidic water to be treated. Therefore, the following problem arises: the higher the load of ion removal, the more frequently backwashing, cleaning, installation of cleaning equipment, and membrane replacement are required; and the device must be stopped each time, leading to a decrease in pure water production efficiency. There has also been such a problem that the scale of the device increases because a hardness removal mechanism, a degassing device, or a membrane degassing device is disposed in the preceding stage side, requiring a large site for installation. Furthermore, there has been a problem of high environmental load because usage of chemicals such as an acid added for degassing or removal of an ion component and a cleaning agent for frequently conducted cleaning and backwashing of a reverse osmosis membrane device is large.

In addition, the water quality of pure water produced by the conventional methods described above using reverse osmosis membranes of three stages is not enough to be directly used for production of a semiconductor, liquid crystal, or the like. Therefore, in order to achieve water quality usable for production of a semiconductor, liquid crystal, or the like, a deionization treatment performed by, for example, a mixed-bed ion exchange resin tower, an electrodeionizer, or the like is further required in a subsequent stage. There is also the following problem: since these devices for performing a deionization treatment can perform the treatment as long as the water quality meets the water quality required by the specifications of the devices, high water quality achieved in conventional methods is not necessary for the treatment in the preceding stage of these devices; and the equipment for the treatment in the preceding stage is thus excessive and unnecessary. For example, when a degassing device (degassing tower) for removing carbonic acid is provided in a preceding stage of the three stages of reverse osmosis membranes, a pump for feeding the treated water of the degassing tower to a subsequent stage is required, making the size of the device larger. In addition, it is also possible to improve water quality by using a high pressure type reverse osmosis membrane, but operation at a high pressure is required in this case, and a problem of high power consumption arises.

An object of the present invention is to provide a pure water production method and a pure water production device, capable of producing pure water that can be fed to a regenerative type deionizer such as a mixed-bed ion exchange resin device or an electrodeionizer using an ultra-low pressure type reverse osmosis membrane device, and the present invention thereby attempts to improve production efficiency of pure water from which boron has been removed.

In summary of the above, the present invention has been made to solve the above-described problems, and an object thereof is to provide a pure water production method, a pure water production device, and an ultra-pure water production system using same, capable of reducing chemical usage by reducing the treatment load on a reverse osmosis membrane device on the preceding stage side and capable of efficiently producing pure water from which boron has been removed.

A pure water production method of the present invention is a pure water production method of treating raw water with at least three stages of ultra-low pressure type reverse osmosis membrane devices to remove boron in the raw water, the pure water production method characterized by including: a step of treating the raw water with a reverse osmosis membrane device of a first stage to obtain first permeate water; a step of adjusting the first permeate water to be alkaline to obtain alkaline water to be treated; a step of treating the alkaline water to be treated with a reverse osmosis membrane device of a second stage to obtain second permeate water; and a step of treating the second permeate water with a reverse osmosis membrane device of a third stage to obtain pure water having a boron concentration of 3 μg/L or more and 20 μg/L or less and an electric conductivity of 0.3 μS/cm or more and 40 μS/cm or less, the pure water production method characterized in that the three stages of the reverse osmosis membrane devices each includes a reverse osmosis membrane, the reverse osmosis membrane is a negatively charged membrane having a skin layer including a cross-linked aromatic polyamide, and the raw water contains 1 mg/L or more and 100 mg/L or less of carbonic acid and 150 μg/L or less of boron.

In the pure water production method of the present invention, it is preferable that the alkaline water to be treated have a pH of 9.0 or higher and 10.0 or lower.

It is preferable that the pure water production method of the present invention further include a step of adding an acid to the second permeate water to obtain second water to be treated, and the second water to be treated be treated with the reverse osmosis membrane device of the third stage.

In the pure water production method of the present invention, it is preferable that the raw water contain chlorine, sulfamic acid be added to the second permeate water in the step to obtain the second water to be treated, and concentrated water of the reverse osmosis membrane device of the third stage be mixed with raw water and treated with the reverse osmosis membrane device of the first stage.

In the pure water production method of the present invention, it is preferable that the second water to be treated have a pH of 5.5 or higher and 7.5 or lower.

In the pure water production method of the present invention, it is preferable that the pure water obtained as permeate water of the reverse osmosis membrane device of the third stage be treated with an electrodeionizer.

A pure water production device of the present invention is a pure water production device for removing boron having a first reverse osmosis membrane device, a second reverse osmosis membrane device, and a third reverse osmosis membrane device connected in series, the pure water production device characterized by including: a raw water feed mechanism that feeds raw water containing 1 mg/L or more and 100 mg/L or less of carbonic acid and 150 μg/L or less of boron to the first reverse osmosis membrane device; a first feed pipe that sends permeate water of the first reverse osmosis membrane device to the second reverse osmosis membrane device; an alkali adjustment mechanism that is provided in a path of the first feed pipe and adjusts water to be treated passing through the first feed pipe to be alkaline; and a second feed pipe that sends permeate water of the second reverse osmosis membrane device to the third reverse osmosis membrane device, the pure water production device characterized in that the first reverse osmosis membrane device, the second reverse osmosis membrane device, and the third reverse osmosis membrane device are ultra-low pressure type reverse osmosis membrane devices, reverse osmosis membranes included in the first reverse osmosis membrane device, the second reverse osmosis membrane device, and the third reverse osmosis membrane device are each a negatively charged membrane having a skin layer including a cross-linked aromatic polyamide, and pure water having a boron concentration of 3 μg/L or more and 20 μg/L or less and an electric conductivity of 0.3 μS/cm or more and 40 μS/cm or less is obtained as permeate water of the third reverse osmosis membrane device.

It is preferable that the pure water production device of the present invention have an electrodeionizer in a subsequent stage of the third reverse osmosis membrane device.

An ultra-pure water production system of the present invention is an ultra-pure water production system including a primary pure water device and a secondary pure water device in this order, in which the primary pure water device includes the pure water production device according to Claim 7 or 8 and an electrodeionizer disposed in a subsequent stage of the pure water production device; the secondary pure water device includes an ultraviolet oxidation device, a non-regenerating polisher, a membrane degassing device, and an ultrafiltration device in this order; and the ultra-pure water production system produces ultra-pure water having a boron concentration of 0.1 μg/L or less.

It should be noted that in the present specification, the symbol “-” represents a numerical value range from a value on the left of the symbol to a value on the right of the symbol.

### Advantageous Effect of Invention

According to a pure water production method and a pure water production device of the present invention, chemical usage can be reduced, and pure water with a boron concentration having been reduced can be efficiently produced by using three stages of reverse osmosis membrane devices on the preceding stage side and reducing the treatment load on the reverse osmosis membrane devices on the preceding stage side.

According to an ultra-pure water production system of the present invention, chemical usage in a pure water production device using three stages of reverse osmosis membrane devices on the preceding stage side can be reduced, and ultra-pure water with high water quality can thus be efficiently produced

### BRIEF DESCRIPTION OF THE DRAWINGS

FIG. 1 is a flow diagram diagrammatically illustrating a pure water production method of an embodiment.

FIG. 2 is a flow diagram diagrammatically illustrating a pure water production method further treating pure water obtained by the pure water production method illustrated in FIG. 1.

FIG. 3 is a flow diagram diagrammatically illustrating a pure water production method of a modification.

FIG. 4 is a block diagram schematically illustrating a pure water production system of an embodiment.

FIG. 5 is a block diagram schematically illustrating a pure water production system of another embodiment.

FIG. 6 is a block diagram schematically illustrating an ultra-pure water production system of an embodiment.

FIG. 7 is a block diagram schematically illustrating a pure water production system used in Examples.

FIG. 8 is a graph showing carbonic acid concentrations in feed water and treated water of a reverse osmosis membrane device of each stage in methods in Examples and Comparative Examples.

FIG. 9 is a graph showing boron concentrations in the feed water and the treated water of the reverse osmosis membrane device of each stage in the methods in the Examples and the Comparative Examples.

FIG. 10 is graph showing electric conductivities of the feed water and the treated water of the reverse osmosis membrane device of each stage in methods in the methods in the Examples and the Comparative Examples.

### DETAILED DESCRIPTION

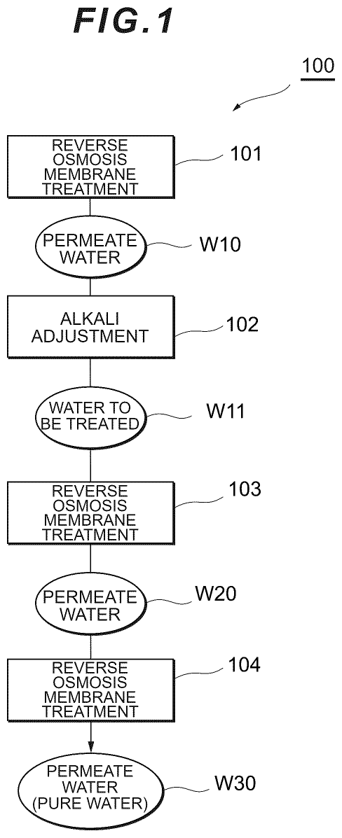

Embodiments of the present invention will be described with reference to drawings below. FIG. 1 is a flow diagram diagrammatically illustrating a pure water production method 100 of an embodiment of the present invention. In the pure water production method 100 illustrated in FIG. 1, raw water is treated with at least three stages of ultra-low pressure type reverse osmosis membrane devices. The pure water production method 100 is, for example, suitable for producing pure water fed to an electrodeionizer or a regenerative type ion exchange resin device.

The pure water production method 100 includes a reverse osmosis membrane treatment step 101 of treating raw water with a reverse osmosis membrane device of a first stage to obtain permeate water W10 (first permeate water), an alkali adjustment step 102 of adjusting the permeate water W10 to be alkaline to obtain alkaline water W11 to be treated, and a reverse osmosis membrane treatment step 103 of treating the alkaline water W11 to be treated with a reverse osmosis membrane device of a second stage to obtain permeate water W20 (second permeate water), and a reverse osmosis membrane treatment step 104 of subjecting the permeate water W20 as water to be treated to a reverse osmosis membrane treatment of a third stage to obtain permeate water W30. The permeate water W30 is pure water produced by the pure water production method 100.

The raw water used in the pure water production method 100 of the present embodiment is, for example, city water, well water, industrial water, or the like. In addition, the raw water may be used and recovered water that has been used at an ultra-pure water usage site, recovered therefrom, and subsequently subjected to a chemical removal treatment or the like as necessary. The raw water (or pretreated water described later) subjected to the reverse osmosis membrane treatment step 101 contains 1 mg/L to 100 mg/L of carbonic acid and 150 μg/L or less of boron. The boron concentration in the raw water is preferably 5 μg/L or more, and the effect of the present invention is likely to be significantly obtained within this range. In addition, the raw water may include a hardness component such as calcium and magnesium in an amount of 10 mg/L to 300 mg/L in total in terms of calcium carbonate, for example. The raw water may also include, for example, about 1 mg/L to 50 mg/L of silica (Si) and about 0.1 mg/L to 0.6 mg/L of chlorine in terms of Cl. The pH of the raw water is about 5.0 to 7.5, for example. Note that carbonic acid includes carbon dioxide, hydrogen carbonate ions, and carbonate ions, and the carbonic acid concentration is a value obtained by converting the total carbonic acid (CO₂+HCO₃—+CO₃²⁻) concentration into a CO₂ concentration.

Instead of or in addition to the raw water fed to the reverse osmosis membrane treatment step 101, pretreated water obtained by preliminarily subjecting raw water to a pretreatment before used in the pure water production method 100 may be used. Examples of the pretreatment are a coagulation sedimentation treatment, a pressurized flotation treatment, a sand filtration treatment, and a microfiltration treatment, and turbidity components such as suspended solids and colloidal substances included in the raw water are removed through these treatments. An activated carbon treatment may be performed in the pretreatment, and chlorine in water is removed thereby. In addition, the water temperature may be adjusted to fall within a range of 15 °C to 30 °C by a heat exchanger in the pretreatment.

All of the three stages of the reverse osmosis membrane devices used in the pure water production method 100 are ultra-low pressure type reverse osmosis membrane devices. The operation pressure of each ultra-low pressure type reverse osmosis membrane is, for example, 0.4 MPa to 1.1 MPa and is preferably 0.6 MPa to 0.7 MPa. Note that the operation pressure of a reverse osmosis membrane device is a design pressure during production of each reverse osmosis membrane, and the reverse osmosis membrane may be operated at a pressure outside the above ranges in practice.

In the pure water production method 100, the feed pressure to the reverse osmosis membrane device in the first stage is adjusted such that water to be treated is fed to each of the first to third reverse osmosis membrane devices at a feed water pressure of preferably 0.4 MPa to 1.1 MPa and more preferably 0.6 MPa to 0.7 MPa. The feed water pressure is represented by a differential pressure obtained by subtracting the permeate water pressure from the pressure (an average of the feed water pressure and the concentrated water pressure) on the feed side of the reverse osmosis membrane device. In the reverse osmosis membrane treatment step 101, the raw water is subjected to a reverse osmosis membrane treatment to remove the hardness component such as calcium and magnesium in the raw water. Concentrated water of the reverse osmosis membrane device of the first stage is discharged to the outside of the system, and the permeate water W10 is sent to a subsequent stage. The removal ratio of the hardness component that can be obtained in the reverse osmosis membrane treatment step 101 is 99% to 99.9%. As the water quality of the permeate water W10, 0.1 mg/L to 3 mg/L of the hardness component such as calcium and magnesium in total in terms of calcium carbonate can be obtained, for example. In addition, as the water quality of the permeate water W10, the carbonic acid concentration is 0.5 mg/L to 50 mg/L, the boron concentration is 3 μg/L to 120 μg/L, and the electric conductivity is 2 μS/cm to 10 μS/cm, for example.

In the alkali adjustment step 102, the permeate water W10 obtained in the reverse osmosis membrane treatment step 101 is adjusted to be alkaline to obtain the alkaline water W11 to be treated. For example, in the alkali adjustment step 102, an aqueous sodium hydroxide solution or an aqueous potassium hydroxide solution, preferably an aqueous sodium hydroxide solution is added to the permeate water W10 to generate the water W11 to be treated. The water W11 to be treated has a pH of preferably 9.0 to 10.0 and has an electric conductivity of preferably 10 μS/cm to 50 μS/cm. In addition, the carbonic acid concentration and the boron concentration of the water W11 to be treated are the same as those of the permeate water W10. When the pH of the water W11 to be treated is set to be 9.0 or higher, the boron removal ratio in the subsequent reverse osmosis membrane treatment step 103 can be improved. In addition, when the pH of the water W11 to be treated is set to be 10.0 or lower, an ion component can be sufficiently removed in the pure water production method 100 while reducing chemical usage. In addition, when the pH of the water W11 to be treated is set to be 10.0 or lower, the chemical (alkali) usage can be reduced, and sodium leakage (leakage of sodium to the permeate water W20) to a subsequent stage can be reduced.

In the reverse osmosis membrane treatment step 103, the water W11 to be treated is fed to the reverse osmosis membrane device of the second stage and subjected to a reverse osmosis membrane treatment. Concentrated water of the reverse osmosis membrane device of the second stage is discharged to the outside of the system or returned to the preceding stage side of the reverse osmosis membrane device of the first stage. The permeate water W20 of the reverse osmosis membrane device of the second stage is sent to a subsequent stage.

Since the water to be treated having been adjusted to be alkaline is treated in the reverse osmosis membrane treatment step 103 as described above, the boron removal ratio can be improved, and the boron removal ratio in the reverse osmosis membrane treatment step 103 can reach 50% to 90%. In addition, in the reverse osmosis membrane treatment step 103, the carbonic acid removal ratio can also be improved, and the carbonic acid removal ratio can reach 95% to 98%. As the water quality of the permeate water W20, the carbonic acid concentration is 0.025 mg/L to 2.5 mg/L, the boron concentration is 3 μg/L to 40 μg/L, the electric conductivity is 1 μS/cm to 40 μS/cm, and the pH is about 8.5 to 10, for example. Note that the boron removal ratio is a value calculated using the formula of [1−(boron concentration in permeate water W20/boron concentration in water W11 to be treated)]×100(%). The carbonic acid removal ratio is a value calculated using the formula of [1−(carbonic acid concentration in permeate water W20/carbonic acid concentration in water W11 to be treated)]×100(%).

In the reverse osmosis membrane treatment step 104, the permeate water W20 from which boron and carbonic acid have been removed is fed as water to be treated to the reverse osmosis membrane device of the third stage and subjected to a reverse osmosis membrane treatment as described above. Concentrated water of the reverse osmosis membrane device of the third stage is discharged to the outside of the system or returned to the preceding stage side of the reverse osmosis membrane device of the first stage. The permeate water W30 of the reverse osmosis membrane device of the third stage is fed as pure water to a point of use (POU) directly or after being sent to a subsequent stage and treated.

In the reverse osmosis membrane treatment step 104, an ion component, for example, an anion component such as chloride ions, sulfate ions, nitrate ions, fluoride ions, and bicarbonate ions, a cation component such as sodium ions and potassium ions, and a weak electrolyte such as boron and silica in the water to be treated (permeate water W20) are removed. As the water quality of the permeate water (pure water) W30 obtained in the reverse osmosis membrane treatment step 104, the boron concentration is 3 μg/L to 20 μg/L and preferably 5 μg/L to 10 μg/L, the carbonic acid concentration is, for example, 0.005 mg/L to 0.5 mg/L, and the electric conductivity is 0.3 μS/cm to 40 μS/cm, preferably 1 μS/cm to 20 μS/cm, and more preferably 1 μS/cm to 10 μS/cm.

The water recovery ratio in the reverse osmosis membrane devices of the three stages are preferably 50% to 80% in the reverse osmosis membrane treatment step 101, 70% to 90% in the reverse osmosis membrane treatment step 103, and 80% to 95% in the reverse osmosis membrane treatment step 104 from the point of obtaining pure water with the above water quality.

The total boron removal ratio that can be obtained through the reverse osmosis membrane devices (steps 101, 103, and 104) of the three stages is 40% to 95%.

Although a method in which reverse osmosis membrane treatments are performed in only three stages is described above, the reverse osmosis membrane treatments may be performed in four or more stages. In this case, a method in which a reverse osmosis membrane treatment is further performed on the upstream side of the reverse osmosis membrane device of the first stage, a method in which a reverse osmosis membrane treatment is further performed between the reverse osmosis membrane devices of the first and second stages, a method in which a reverse osmosis membrane treatment is further performed between the reverse osmosis membrane devices of the second and third stages, a method in which a reverse osmosis membrane treatment is further performed on the downstream side of the reverse osmosis membrane device of the third stage, or a method of any combination thereof can be employed. Any of an ultra-low pressure type, low pressure type, and high pressure type reverse osmosis membrane devices may be used in the additional reverse osmosis membrane treatment. Among them, the method in which a reverse osmosis membrane treatment of an ultra-low pressure type is further performed between the reverse osmosis membrane devices of the second and third stages is preferable, and a further reduction in boron concentration can be achieved by this method.

The operation pressure of a low pressure type reverse osmosis membrane is, for example, more than 0.8 MPa and less than 2.5 MPa and preferably 1 MPa to 1.6 MPa. The operation pressure of a high pressure type reverse osmosis membrane is, for example, more than 2.5 MPa and 8 MPa or less. Note that the operation pressures of the ultra-low pressure type, low pressure type, and high pressure type reverse osmosis membrane devices are design pressures during production of the respective reverse osmosis membranes, and the reverse osmosis membranes may be operated at a pressure outside the above ranges in practice.

According to the pure water production method 100 of the embodiment described above, an excellent carbonic acid removal ratio can be achieved in the reverse osmosis membrane treatment step 103 performed in the reverse osmosis membrane device of the second stage, and a hardness removal mechanism and a degassing device for removing carbonic acid on the preceding stage side can thus be omitted. Therefore, chemical usage can be reduced, and the device can be simplified, enabling efficient production of pure water at a low cost. Further, the number of water feed pumps and output can be reduced by setting the feed water pressure in the reverse osmosis membrane treatment steps in the three stages to an ultra-low pressure as described above, leading to further simplification of the device, reduction in pure water production costs, and improvement of production efficiency.

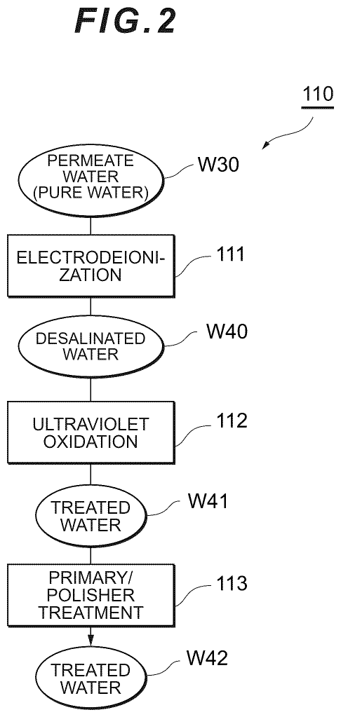

Next, a preferable method for treating the permeate water W30 will be described. FIG. 2 is a flow diagram diagrammatically illustrating a pure water production method 110 of an embodiment. The pure water production method 110 is an example of a method of treating permeate water W30 to produce pure water with higher purity. The pure water production method 110 includes an electrodeionization step 111 of treating the permeate water W30 with an electrodeionizer, an ultraviolet oxidation step 112 of subjecting, to ultraviolet oxidation, desalinated water W40 obtained in the electrodeionization step 111 as water to be treated, and a non-regenerative type ion exchange resin (primary/polisher) treatment step 113 of removing an ion component in treated water W41 of the ultraviolet oxidation step 112.

In the electrodeionization step 111, the permeate water W30 is fed to an electrodeionizer (EDI), and an ion component in the permeate water W30 is removed. The electrodeionizer alternately has a desalination chamber and a concentration chamber into which concentrated water including a removed ion component flows, with the desalination chamber and the concentration chamber partitioned by an anion exchange membrane and a cation exchange membrane, for example. The electrodeionizer further has a mixture of an anion exchange resin and a cation exchange resin filling the desalination chamber, and an electrode for applying a DC voltage.

In the electrodeionizer, water to be treated is passed through the anion exchange resin and the cation exchange resin in a state where a direct current is applied to the electrode, and the ion component in the water to be treated is then adsorbed to the ion exchange resins. The adsorbed ion component migrates to surfaces of the ion exchange membranes by means of electrophoresis, undergoes electrodialysis through the ion exchange membranes, is transferred to the concentration chamber, and is discharged into concentrated water. In the desalination chamber, dissociation reaction of water progresses, H⁺ and OH⁻ ions are generated, and the ion exchange resins in the desalination chamber are continuously regenerated. The desalinated water W40 collected in the desalination chamber is sent to a subsequent stage, and the concentrated water in the concentration chamber is discharged to the outside of the system.

As a treatment condition in the electrodeionization step 111, the current density in the desalination chamber is preferably 0.2 A/dm² to 1.0 A/dm². Consequently, the regeneration efficiency of the ion exchange resins in the desalination chamber can be improved, and the ion removal efficiency can be improved. The current density of the desalination chamber can be adjusted by the voltage between the anode and the cathode of the electrodeionizer. In addition, the water quality of the desalinated water obtained in the electrodeionization step satisfies, for example, a resistivity of 15 MΩ·cm to 18 MΩ·cm.

The electrodeionizer (EDI) used in the electrodeionization step 111 includes VNX series (manufactured by Evoqua Water Technologies LLC) such as IP-VNX-MAX model, E-Cell series (manufactured by SUEZ WTS Analytical Instruments) such as SUEZMK3-27EU model, and MDI series (manufactured by ECORBIT corp.) such as UX5015 model.

In the pure water production method 110 of the present embodiment, the water quality of pure water obtained by the pure water production method 100 satisfies water quality acceptable in the electrodeionization step 111, and deionization in the electrodeionization step 111 can thus be appropriately performed. As a specific example of the water quality acceptable in the electrodeionization step 111, the boron concentration is 3 μg/L to 20 μg/L, the electric conductivity is 0.3 μS/cm to 40 μS/cm, and the carbonic acid concentration is 0.001 mg/L to 3 mg/L, for example.

Thereafter, the desalinated water W40 obtained in the electrodeionization step 111 is fed to the ultraviolet oxidation device in the ultraviolet oxidation step 112. The ultraviolet oxidation device has, for example, an ultraviolet lamp capable of irradiation with ultraviolet light having a wavelength around 185 nm, and the water to be treated is irradiated with ultraviolet light from the ultraviolet lamp to oxidatively decompose a total organic carbon component (TOC) in the water to be treated. As the ultraviolet lamp used in the ultraviolet oxidation device, a lamp that generates ultraviolet light having a wavelength of around 185 nm can be used. A low-pressure mercury lamp that emits ultraviolet light having a wavelength of around 254 nm together with ultraviolet light having a wavelength of around 185 nm may be used as the ultraviolet lamp. Water is decomposed by ultraviolet light emitted from the ultraviolet oxidation device to generate OH radicals, and the OH radicals oxidatively decompose organic substances in the water to be treated (the desalinated water W40 described above) into organic acids. The ultraviolet irradiation amount in the ultraviolet oxidation step 112 can be appropriately changed depending on the water quality of the water to be treated.

Treated water W41 generated in the ultraviolet oxidation step 112 is then fed to a non-regenerative type ion exchange resin device (primary/polisher) in the non-regenerative type ion exchange resin (primary/polisher) treatment step 113. The non-regenerative type ion exchange resin device is configured by mixing a strongly acidic cation exchange resin and a strongly basic anionic exchange resin and filling a resin tower with same, and removes an ion component in the treated water W41. The ion component removed here is mainly a trace organic acid and the like generated through decomposition of an organic substance in the ultraviolet oxidation step 112.

Treated water W42 generated through the non-regenerative type ion exchange resin treatment step 113 can have a resistivity of 18 MΩ·cm or more, and the TOC concentration thereof is reduced to, for example, 10 μgC/L or less. Incidentally, the non-regenerative type ion exchange resin treatment step 113 may not be executed, and it is also possible that the ultraviolet oxidation step 112 is executed before the electrodeionization step 111, and the permeate water W30 is treated in the ultraviolet oxidation step 112 and the electrodeionization step 111 in this order, in this case.

According to the pure water production method 110 as described above, since the electrodeionization step 111 is adopted, the ion component can be continuously removed without using chemicals such as an acid or an alkali, which are usually used to regenerate ion exchange resins at all. Therefore, it is possible to realize a reduction in pure water production costs, a reduction in size of the device, a reduction in environmental load, and the like, leading to an improvement of production efficiency. In addition, since the ion component can be almost completely removed in the electrodeionization step 111, the treatment load on the three stages of the reverse osmosis membrane devices in a preceding stage can be reduced, and a reduction in pure water production costs, a reduction in size of the device, a reduction in environmental load, and the like can be realized as a result.

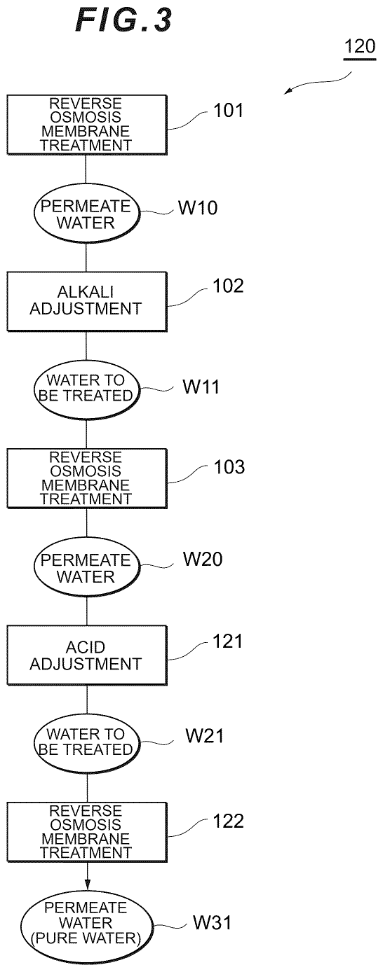

Next, a pure water production method 120 according to a modification of the pure water production method 100 of the embodiment will be described with reference to FIG. 3. The pure water production method of this modification differs from the pure water production method 100 illustrated in FIG. 1 in the point that the pure water production method 100 includes an acid adjustment step of adding an acid to the permeate water W20 to generate second water to be treated having a pH lower than that of alkaline water to be treated. That is, the pure water production method 120 of the modification includes: a reverse osmosis membrane treatment step 101 of treating raw water with a reverse osmosis membrane device of a first stage to obtain permeate water W10 (first permeate water); an alkali adjustment step 102 of adjusting the permeate water W10 to be alkaline to obtain alkaline water W11 to be treated; a reverse osmosis membrane treatment step 103 of treating the alkaline water W11 to be treated with a reverse osmosis membrane device of a second stage to obtain permeate water W20 (second permeate water); an acid adjustment step 121 of adding an acid to the permeate water W20 to obtain second water W21 to be treated; and a reverse osmosis membrane treatment step 122 of treating the second water W21 to be treated with a reverse osmosis membrane device of a third stage to obtain permeate water W31. The permeate water W31 is pure water produced by the pure water production method 120.

In the acid adjustment step 121, acidity is imparted to the permeate water W20 obtained in the reverse osmosis membrane treatment step 103 to obtain the second water W21 to be treated. For example, in the acid adjustment step 121, hydrochloric acid, sulfuric acid, an aqueous sulfamic acid solution, or the like is added to the permeate water W20 to generate the water W21 to be treated. The liquid property of the water W21 to be treated is preferably weakly acidic to weakly alkaline from the viewpoint of reducing environmental load. Specifically, the pH of the water W21 to be treated is preferably 5.5 to 7.5, and more preferably 6.5 to 7.5. By setting the pH of the second water W21 to be treated to 5.5 or higher, the removal ratio of a cation component in the subsequent reverse osmosis membrane treatment step 122 can be improved, and the water quality of the treated water can be improved because an acid is not excessively added. Salts (ion component) permeated in a trace amount in the reverse osmosis membrane treatment step 103 are present in the permeate water W20 of the reverse osmosis membrane treatment step 103 in a form of a hydroxide salt such as sodium hydroxide. Therefore, removal of salts in the reverse osmosis membrane treatment step 122 is facilitated by setting the pH of the water W21 to be treated to 7.5 or lower, because the hydroxide salt is converted into a form of a sulfamate such as sodium sulfamate. In addition, when the pH of the water W21 to be treated is set to be 5.5 or higher, the treatment load in the reverse osmosis membrane treatment step 122 can be reduced. In addition, as the acid added in the acid adjustment step 121, an aqueous sulfamic acid solution is preferably used among the above-described acids from the point of reducing chemical usage and reducing environmental load.

When sulfamic acid is used in the acid adjustment step 121, it is preferable that the raw water be not subjected to an activated carbon treatment, and the chlorine concentration in the raw water be 0.1 μg/L to 0.4 μg/L. By circulating the concentrated water generated in the reverse osmosis membrane treatment step 122 to the feed side of the reverse osmosis membrane device of the first stage, chlorine in the raw water and sulfamic acid in the concentrated water react with each other to exhibit bactericidal power, and an effect to suppress biofouling in the three stages of the reverse osmosis membrane devices is obtained. In particular, biofouling in the reverse osmosis membrane in the first stage in which biofouling is most likely to occur intensively can be prevented. Consequently, the amount of a bactericidal agent usually added to the water to be treated for disinfection can be reduced, leading to a reduction in environmental load. In addition, free chlorine in the water to be treated, which degrades reverse osmosis membranes, can be changed to combined chlorine by adding sulfamic acid, and an effect to reduce the load on the reverse osmosis membranes can also be provided thereby. As described above, in the pure water production method 120 of the present modification, by adding sulfamic acid in the acid adjustment step 121, two effects of improvement of the removal ratio of the weak electrolyte in the reverse osmosis membrane treatment step 122 and suppression of biofouling on reverse osmosis membranes in the three stages can be obtained. Therefore, in a conventional pure water production method, it has been necessary to add two kinds of acids at two locations: the feed water for the reverse osmosis membrane of the first stage and the feed water for the reverse osmosis membrane of the third stage. However, in the pure water production method 120 of the present modification, the number of kinds of acids added can be reduced to one, and the location at which the acid is added is limited to a single location in the acid adjustment step 121.

When sulfamic acid is used in the acid adjustment step 121, the amount of sulfamic acid added is preferably within a range in which the total amount of chemicals used in the pure water production method 120 can be reduced, balancing the reduced amount of the bactericidal agent described above with the amount of sulfamic acid added, and is, for example, 1 mg/L to 10 mg/L based on the water to be treated.

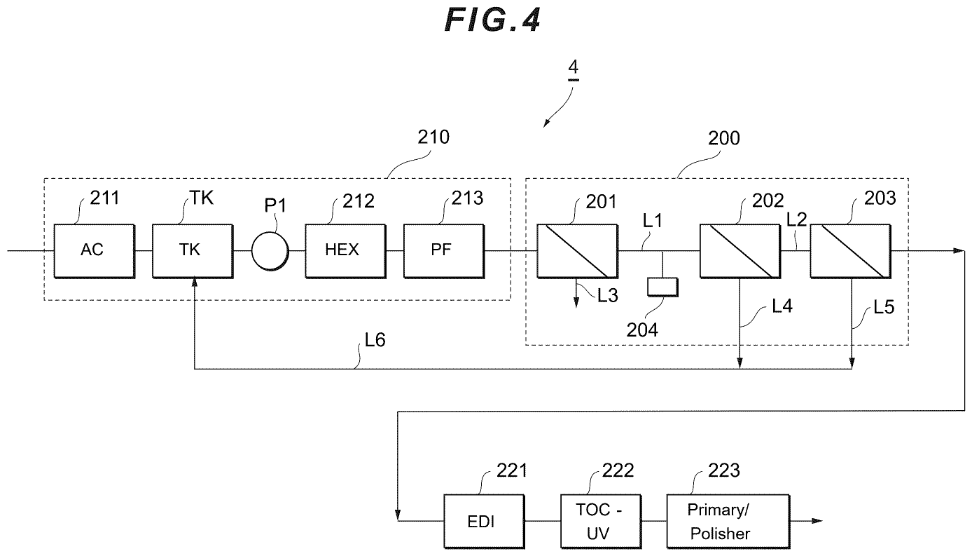

Next, a pure water production device 200 according to an embodiment of the present invention will be described. FIG. 4 is a block diagram schematically illustrating a pure water production system 4 including the pure water production device 200 of the embodiment. The pure water production device 200 includes three stages of ultra-low pressure type reverse osmosis membrane devices 201, 202, and 203.

A pretreatment device 210 is provided as a raw water feed mechanism in a preceding stage of the pure water production device 200. The pretreatment device 210 includes an activated carbon unit (AC) 211, a storage tank TK, a pump P1, a heat exchanger (HEX) 212, and a microfiltration device (PF) 213 in this order. The configuration of the pretreatment device 210 can be appropriately changed depending on the water quality of the raw water. For example, the pretreatment device 210 may not include the activated carbon unit (AC) 211, the heat exchanger (HEX) 212, and the microfiltration device (PF) 213, or may be configured by arbitrarily combining a coagulation sedimentation device, a pressurized flotation device, a sand filtration device, and the like in addition to the activated carbon unit (AC) 211, the storage tank TK, the heat exchanger (HEX) 212, and the microfiltration device (PF) 213 described above.

An electrodeionizer (EDI) 221, an ultraviolet oxidation device (TOC-UV) 222, and a non-regenerative type ion exchange resin device (primary/polisher) 223 are disposed in this order in a subsequent stage of the pure water production device 200. The electrodeionizer (EDI) 221, the ultraviolet oxidation device (TOC-UV) 222, and the non-regenerative type ion exchange resin device (primary/polisher) 223 may also be appropriately disposed according to desired water quality.

The pure water production device 200 has a feed pipe L1 (first feed pipe) that sends permeate water of the reverse osmosis membrane device 201 to the reverse osmosis membrane device 202, and a feed pipe L2 (second feed pipe) that sends permeate water of the reverse osmosis membrane device 202 to the reverse osmosis membrane device 203. In addition, discharge pipes L3, L4, and L5 are connected to the concentration sides of the reverse osmosis membrane devices 201, 202, and 203, respectively. The pure water production device 200 has a circulation pipe L6. One end of the circulation pipe L6 is connected to the tank TK, and the other end thereof is connected to the discharge pipes L4 and L5. Consequently, the circulation pipe L6 circulates concentrated water of the reverse osmosis membrane devices 202 and 203 to the tank TK.

The reverse osmosis membrane devices 201, 202, and 203 each include, for example, one or more reverse osmosis membrane modules configured such that a reverse osmosis membrane and a flow path material for passing water to be treated through the reverse osmosis membrane are housed in a casing. The reverse osmosis membranes included in the reverse osmosis membrane devices 201, 202, and 203 are negatively charged membranes each having a skin layer including a cross-linked aromatic polyamide. These reverse osmosis membranes are asymmetric membranes or composite membranes, and are preferably composite membranes which are formed from a poly(aryl ether sulfone) such as a polysulfone or a polyethersulfone, a polyimide, or a polyvinylidene fluoride, have a support layer having fine pores, and have the skin film provided on the support layer. Note that the negatively charged membrane refers to a membrane that includes a skin layer and exhibits a negative charge at a pH of 7. The reverse osmosis membranes each have a hollow fiber shape, a spiral shape, a flat plate shape, a tube shape, or the like. These reverse osmosis membranes preferably have a spiral shape from the point of increasing pressure resistance and improving the treatment efficiency.

The reverse osmosis membranes used in the reverse osmosis membrane devices 201, 202, and 203 preferably have a salt rejection rate (salt removal ratio) of 99.0% or more, more preferably 99.2% or more, still more preferably 99.5% or more, and even more preferably 99.6% or more. Incidentally, the salt rejection rate is represented by the removal ratio of sodium chloride when an aqueous sodium chloride solution having a pH of 7 and a concentration of 500 ppm or 1500 ppm is fed at a water temperature of 25 °C, a water recovery ratio of 15%, and a feed pressure of 1.03 MPa or 0.69 to 0.7 MPa.

Examples of ultra-low pressure type reverse osmosis membrane devices using an ultra-low pressure type membrane as the reverse osmosis membrane devices 201, 202, and 203 include ESPA series manufactured by Nitto Denko Corporation, TBW series and TMHA series manufactured by Toray Industries, Inc., and the like.

The feed pipe L1 is provided with an alkali adjustment mechanism 204 that adjusts the water to be treated passing through the feed pipe L1 to be alkaline. The alkali adjustment mechanism 204 includes, for example, a tank that stores an alkali adjusting agent such as an aqueous sodium hydroxide solution or potassium hydroxide solution, and a chemical injection pump that measures a predetermined amount of the alkali adjusting agent in the tank and adds same into the feed pipe L1.

The production of pure water using the pure water production device 200 illustrated in FIG. 4 is the same as the pure water production method 100 (FIG. 1) of the above-described embodiment. Raw water including city water, well water, industrial water, used recovered water, or the like is first fed to the pretreatment device 210. As the raw water passes through the pretreatment device, turbidity components and chlorine in the water are removed, and the water temperature is then adjusted to 15 °C to 30 °C to generate pretreated water.

The pretreated water obtained in this manner contains 1 mg/L to 100 mg/L of carbonic acid and 150 μg/L or less of boron, and the boron concentration thereof is preferably 5 μg/L or more. The pH of the pretreated water is, for example, about 5.0 to 7.5.

The pretreated water is pressurized by the pump P1 and fed to the reverse osmosis membrane device 201. The pretreated water is subjected to a reverse osmosis membrane treatment in the reverse osmosis membrane device 201 to remove a hardness component in the water, and permeate water W10 is generated (reverse osmosis membrane treatment step 101 in FIG. 1). Concentrated water of the reverse osmosis membrane device 201 is discharged to the outside of the system via the discharge pipe L3. The permeate water W10 is sent to a subsequent stage via the feed pipe L1.

The permeate water W10 is adjusted to be alkaline by the alkali adjustment mechanism 204 in the process of passing through the feed pipe L1 (alkali adjustment step 102 in FIG. 1). Specifically, the alkali adjustment mechanism 204 quantitatively injects the alkali adjusting agent into the feed pipe L1, and the alkali adjusting agent is thus mixed with the permeate water W10 to generate water W11 to be treated having been adjusted to be alkaline. The pH of the water W11 to be treated is preferably 9.0 to 10.0.

The alkaline water W11 to be treated is then fed to the reverse osmosis membrane device 202. The water W11 to be treated is subjected to a reverse osmosis membrane treatment in the reverse osmosis membrane device 202 to remove boron and carbonic acid in the water, and permeate water W20 is generated (reverse osmosis membrane treatment step 103 in FIG. 1). Since the water W11 to be treated is alkaline as described above, the boron removal ratio can reach 50% to 90%, and the carbonic acid removal ratio can reach 95% to 98% in the reverse osmosis membrane device 202. The concentrated water of the reverse osmosis membrane device 202 is circulated to the tank TK via the discharge pipe L4 and the circulation pipe L6. The permeate water W20 is sent to a subsequent stage via the feed pipe L2.

The permeate water W20 is then fed to the reverse osmosis membrane device 203. The permeate water W20 is subjected to a reverse osmosis membrane treatment in the reverse osmosis membrane device 203 to remove an ion component in the water, and permeate water W30 is generated (reverse osmosis membrane treatment step 104 in FIG. 1). The concentrated water of the reverse osmosis membrane device 203 is circulated to the tank TK via the discharge pipe L5 and the circulation pipe L6. The permeate water (pure water) W30 is sent to a subsequent stage.

The water quality of the permeate water (pure water) W30 obtained in the reverse osmosis membrane treatment step 104 is, for example, as follows: the boron concentration is 3 μg/L to 20 μg/L and preferably 5 μg/L to 10 μg/L; the carbonic acid concentration is 0.005 mg/L to 0.5 mg/L; and the electric conductivity is 0.3 μS/cm to 40 μS/cm, preferably 1 μS/cm to 20 μS/cm, and more preferably 1 μS/cm to 10 μS/cm.

In addition, from the point of obtaining pure water (permeate water W30) with the above water quality, the water recovery ratio in the three stages of the reverse osmosis membrane devices is preferably 50% to 80% in the reverse osmosis membrane device 201, 70% to 90% in the reverse osmosis membrane device 202, and 80% to 95% in the reverse osmosis membrane device 203.

The permeate water W30 is subsequently fed to the electrodeionizer (EDI) 221, the ultraviolet oxidation device 222, and the non-regenerative type ion exchange resin device 223 in sequence. Consequently, the pure water production method 110 illustrated in FIG. 2 is executed. The permeate water W30 is first fed to the electrodeionizer 221 to remove an ion component in the permeate water W30 (the electrodeionization step 111 in FIG. 2). In the electrodeionizer 221, by passing the water to be treated through an anion exchange resin and a cation exchange resin in a state where a direct current is applied to an electrode, the ion component in the water to be treated is adsorbed by the ion exchange resins. The adsorbed ion component migrates to surfaces of ion exchange membranes by means of electrophoresis, undergoes electrodialysis through the ion exchange membranes, is transferred to a concentration chamber, and is discharged into concentrated water. Desalinated water W40 from which the ion component has been removed is sent to a subsequent stage, and the concentrated water in the concentration chamber is discharged to the outside of the system.

The desalinated water W40 is fed to the ultraviolet oxidation device 222, and the desalinated water W40 is irradiated with ultraviolet light (ultraviolet oxidation step 112 in FIG. 2). A total organic carbon content (TOC) in the desalinated water W40 is oxidatively decomposed thereby. The ultraviolet light used for irradiation is preferably ultraviolet light having a wavelength of around 185 nm, and more preferably ultraviolet light having a wavelength of around 185 nm and ultraviolet light having a wavelength of around 254 nm.

Treated water W41 generated in the ultraviolet oxidation device 222 is then fed to the non-regenerative type ion exchange resin device 223 to remove an ion component in the treated water W41 (non-regenerative type ion exchange resin treatment step 113 in FIG. 2). Treated water W42 generated through the non-regenerative type ion exchange resin device 223 can have a resistivity of 18 MΩ·cm or more, and the TOC concentration thereof is reduced to, for example, 10 μgC/L or less.

Incidentally, the non-regenerative ion exchange resin device (primary/polisher) 223 may not be provided. In this case, the ultraviolet oxidation device 222 can be disposed prior to the electrodeionizer (EDI) 221, and the permeate water W30 can be treated with the ultraviolet oxidation device 222 and the electrodeionizer (EDI) 221 in this order.

According to the pure water production device 200 described above, since an excellent carbonic acid removal ratio can be achieved in the reverse osmosis membrane device 202, a hardness removal mechanism and a degassing device for removing carbonic acid on the preceding stage side can be omitted. In addition, since a hardness removal mechanism and a degassing device can be omitted, and the treatment load on the pure water production device 200 is also reduced, chemical usage can be reduced, and the device can be simplified. As a result, pure water can be efficiently produced at a low cost. Further, the number of water feed pumps and output can be reduced by setting the feed water pressure in the reverse osmosis membrane treatment steps in the three stages to an ultra-low pressure as described above, leading to further simplification of the device, reduction in pure water production costs, and improvement of production efficiency.

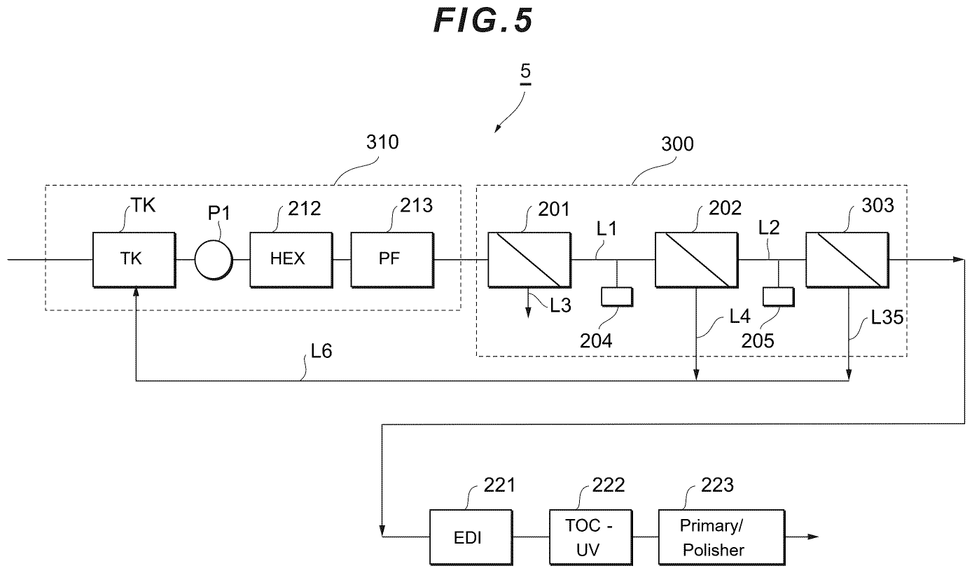

Next, a pure water production device 300, which is a modification of the pure water production device 200 of the embodiment, will be described. FIG. 5 is a block diagram schematically illustrating a pure water production system 5 including the pure water production device 300. The pure water production device 300 is a device for realizing the pure water production method 120 of the embodiment described above, differs from the pure water production system 4 illustrated in FIG. 4 in the point that an acid adjustment mechanism 205 is provided in a path of the feed pipe L2, and differs in the treatment mode in the reverse osmosis membrane device of the third stage as a result. The other components and effects are same as those of the pure water production device 200. Therefore, components providing the same effects as those in the pure water production device 200 are denoted by the same reference numerals, and detailed description thereof is omitted.

The pure water production system 5 includes a pretreatment device 310 in a preceding stage of the pure water production device 300. The pretreatment device 310 includes a storage tank TK, a pump P1, a heat exchanger (HEX) 212, and a microfiltration device (PF) 213 in this order. In a subsequent stage of the pure water production device 300, an electrodeionizer (EDI) 221, an ultraviolet oxidation device (TOC-UV) 222, and a non-regenerative type ion exchange resin device (primary/polisher) 223 are disposed in this order.

The pure water production device 300 includes three stages of reverse osmosis membrane devices 201, 202, and 303. In addition, the pure water production device 300 has a feed pipe L1 (first feed pipe) that sends permeate water of the reverse osmosis membrane device 201 to the reverse osmosis membrane device 202, and a feed pipe L2 (second feed pipe) that sends permeate water of the reverse osmosis membrane device 202 to the reverse osmosis membrane device 203. In addition, discharge pipes L3, L4, and L35 are connected to the concentration sides of the reverse osmosis membrane devices 201, 202, and 303, respectively. The pure water production device 300 has a circulation pipe L6. One end of the circulation pipe is connected to the tank TK, and the other end thereof is connected to the discharge pipes L4 and L35, and the circulation pipe L6 thus circulates concentrated water of the reverse osmosis membrane devices 202 and 303 to the tank TK.

The configuration of the reverse osmosis membrane device 303 is same as those of the reverse osmosis membrane devices 201 and 202 described above and is an ultra-low pressure type reverse osmosis membrane device.

The feed pipe L1 is provided with an alkali adjustment mechanism 204 that adjusts water to be treated passing through the feed pipe L1 to be alkaline. The alkali adjustment mechanism 204 includes, for example, a tank that stores an alkali adjusting agent such as an aqueous sodium hydroxide solution or potassium hydroxide solution, and a chemical injection pump that measures a predetermined amount of the alkali adjusting agent in the tank and adds same into the feed pipe L1.

The feed pipe L2 is provided with an acid adjustment mechanism 205 that adds an acid to water to be treated passing through the feed pipe L2. The acid adjustment mechanism 205 includes, for example, a tank that stores an acid adjusting agent such as hydrochloric acid, sulfuric acid, or sulfamic acid, and a chemical injection pump that measures a predetermined amount of the acid adjusting agent in the tank and adds same into the feed pipe L2. The acid added by the acid adjustment mechanism 205 is preferably sulfuric acid among those described above.

Production of pure water using the pure water production device 300 illustrated in FIG. 5 is same as in the pure water production method 120 (FIG. 3) of the embodiment described above. Raw water including city water, well water, industrial water, used and recovered water, or the like is first fed to a pretreatment device 310. Turbidity components in water is removed from the raw water through the pretreatment device 310, and the water temperature is further adjusted to 15 °C to 30 °C to generate pretreated water.

The pretreated water obtained in this manner contains 1 mg/L to 100 mg/L of carbonic acid and 150 μg/L or less of boron. In addition, the pretreated water includes, for example, about 0.1 mg/L to 0.4 mg/L of chlorine in terms of Cl. The pH of the pretreated water is, for example, about 5.0 to 7.5.

The pretreated water is pressurized by the pump P1 and fed to the reverse osmosis membrane device 201 at a feed water pressure of preferably 0.4 MPa to 1.1 MPa and more preferably 0.6 MPa to 0.7 MPa, and a hardness component in the water is removed to generate permeate water W10 (reverse osmosis membrane treatment step 101 in FIG. 3). Concentrated water of the reverse osmosis membrane device 201 is discharged to the outside of the system via the discharge pipe L3. The permeate water W10 is sent to a subsequent stage via the feed pipe L1.

The permeate water W10 is adjusted to be alkaline by the alkali adjustment mechanism 204 (alkali adjustment step 102 in FIG. 3) in the process of passing through the feed pipe L1. Specifically, the alkali adjustment mechanism 204 quantitatively injects the alkali adjusting agent into the feed pipe L1, and the alkali adjusting agent is thus mixed with the permeate water W10 to generate water W11 to be treated having been adjusted to be alkaline. The pH of the water W11 to be treated is preferably 9.0 to 10.0 when sulfamic acid is used in the acid adjustment mechanism 205.

The alkaline water W11 to be treated is then fed to the reverse osmosis membrane device 202. The water W11 to be treated is subjected to a reverse osmosis membrane treatment in the reverse osmosis membrane device 202, and boron and carbonic acid in the water are removed to generate permeate water W20 (reverse osmosis membrane treatment step 103 in FIG. 3). Concentrated water of the reverse osmosis membrane device 202 is circulated to the tank TK via the discharge pipe L4 and the circulation pipe L6. The permeate water W20 is sent to a subsequent stage via the feed pipe L2.

An acid is added to the permeate water W20 by the acid adjustment mechanism 205 (acid adjustment step 121 in FIG. 3) in the process of passing through the feed pipe L2. Specifically, the acid adjustment mechanism 205 quantitatively injects the acid adjusting agent into the feed pipe L2, and the acid adjusting agent, preferably sulfamic acid is thus mixed with the permeate water W20 to generate water W21 to be treated having a pH lower than that of the water W11 to be treated. The pH of the water W21 to be treated is preferably 5.5 to 7.5 and more preferably 6.5 to 7.5 when sulfamic acid is used in the acid adjustment mechanism 205.

The water W21 to be treated is then fed to the reverse osmosis membrane device 303, and an ion component in the water is removed to generate permeate water W30 (reverse osmosis membrane treatment step 122 in FIG. 3). Concentrated water of the reverse osmosis membrane device 303 is circulated to the tank TK via the discharge pipe L35 and the circulation pipe L6. Permeate water (pure water) W31 is sent to a subsequent stage. Since an acid is added to the water W21 to be treated, the removal ratio of the ion component in the reverse osmosis membrane device 303 can be improved.

The water quality of the permeate water (pure water) W31 obtained by the reverse osmosis membrane treatment 303 is as follows: the boron concentration is 3 g/L to 20 μg/L and preferably 5 μg/L to 10 μg/L; the carbonic acid concentration is, for example, 0.1 mg/L to 1 mg/L and preferably 0.2 mg/L to 0.5 mg/L; and the electric conductivity is 0.3 μS/cm to 40 μS/cm, preferably 1 μS/cm to 20 μS/cm, and more preferably 1 μS/cm to 10 μS/cm.

The permeate water W31 is subsequently fed to the electrodeionizer (EDI) 221, the ultraviolet oxidation device 222, and the non-regenerative type ion exchange resin device 223 in sequence. An ion component in the permeate water W31 is removed in the electric deionizer (EDI) 221. Desalinated water from which the ion component has been removed is sent to a subsequent stage, and concentrated water in a concentration chamber is discharged to the outside of the system. The desalinated water is irradiated with ultraviolet light in the ultraviolet oxidation device 222 as described above, and a total organic carbon content (TOC) in the desalinated water is oxidatively decomposed. Treated water generated through irradiation with ultraviolet light is then fed to the non-regenerative type ion exchange resin device 223 to remove an ion component in the treated water. Treated water generated through the non-regenerative type ion exchange resin device 223 can have a resistivity of 18 MΩ·cm or more, and the TOC concentration thereof is reduced to, for example, 10 μgC/L or less.

Incidentally, the non-regenerative type ion exchange resin device (primary/polisher) 223 may not be provided also in the present modification. In this case, the ultraviolet oxidation device 222 can be disposed prior to the electrodeionizer (EDI) 221, and the permeate water W30 can be treated with the ultraviolet oxidation device 222 and the electrodeionizer (EDI) 221 in this order.

When sulfamic acid is used in the acid adjustment mechanism 205, by circulating the concentrated water generated in the reverse osmosis membrane device 303 to the tank TK in the preceding stage of the reverse osmosis membrane device 201, chlorine in the raw water and sulfamic acid in the concentrated water react with each other to exhibit bactericidal power, and an effect to suppress biofouling in the three stages of the reverse osmosis membrane devices is obtained. In particular, biofouling in the reverse osmosis membrane in the first stage in which biofouling is most likely to occur intensively can be prevented. Consequently, the amount of a bactericidal agent usually added to the water to be treated for disinfection can be reduced, leading to a reduction in environmental load. In addition, free chlorine in the water to be treated, which degrades reverse osmosis membranes, can be changed to combined chlorine by adding sulfamic acid, and an effect to reduce the load on the reverse osmosis membranes can also be provided thereby. By adding sulfamic acid by the acid adjustment mechanism 205, two effects of improvement of the removal ratio of the weak electrolyte in the reverse osmosis membrane device 202 and suppression of biofouling in the reverse osmosis membrane device 303 of the third stage can be obtained. In a conventional pure water production method, it has been necessary to add two kinds of acids at two locations: the feed water for the reverse osmosis membrane of the first stage and the feed water for the reverse osmosis membrane of the third stage. However, in the pure water production device 200, the number of kinds of acids added can be reduced to one, and the location at which the acid is added is limited to a single location of the acid adjustment mechanism 205.

When sulfamic acid is used in the acid adjustment mechanism 205, the amount of sulfamic acid added is preferably within a range in which the total amount of chemicals used can be reduced, balancing the reduced amount of the bactericidal agent described above with the amount of sulfamic acid added.

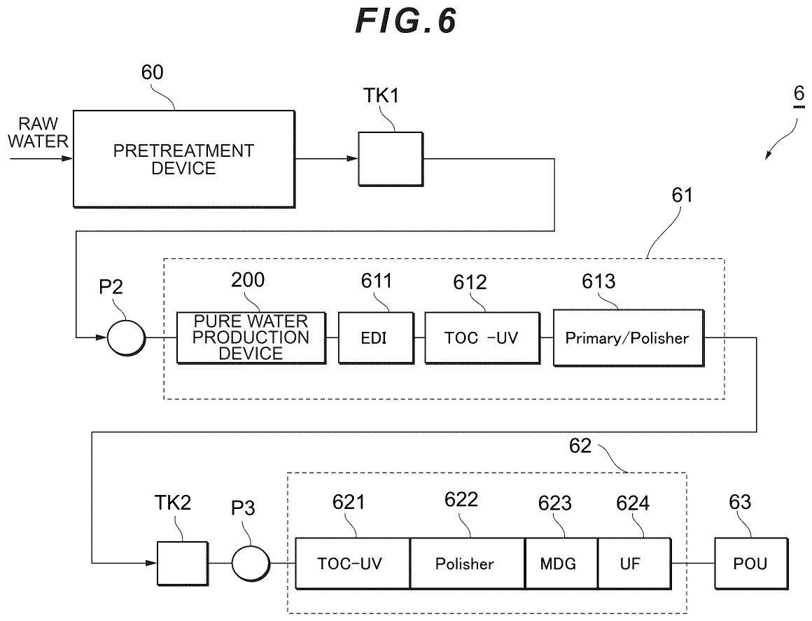

Next, an ultra-pure water production system 6 of an embodiment using the above-described pure water production device 200 will be described with reference to FIG. 6. FIG. 6 is a block diagram diagrammatically illustrating a configuration of the ultra-pure water production system 6.

As illustrated in FIG. 6, the ultra-pure water production system 6 includes a pretreatment device 60, a primary pure water device 61, and a secondary pure water device (sub-system) 62 in this order. The secondary pure water device 62 is connected to a point of use (POU) 63 by piping, and ultra-pure water produced by the ultra-pure water production system 6 is fed to the POU 63 thereby.

The pretreatment device 60 performs processes such as coagulation, filtration, and membrane separation, and if necessary, performs temperature control using a heat exchanger or the like to remove turbidity components such as suspended solids and colloidal substances included in water to be treated (raw water). Specifically, the pretreatment device 60 includes an appropriate combination of an activated carbon unit, a coagulation sedimentation device, a pressurized flotation device, a sand filtration device, a microfiltration device, an ultrafiltration device, a heat exchanger, and the like. In addition, the pretreatment device 60 may have the same configuration as the pretreatment device 210 (FIG. 4) or the pretreatment device 310 (FIG. 5) described above. Note that when the water quality of the raw water is sufficient to be fed to the primary pure water device 61, the pretreatment device 60 may be omitted.

The ultra-pure water production system 6 includes a tank TK1 in a subsequent stage of the pretreatment device 60, and the water to be treated pretreated by the pretreatment device 60 is introduced into the tank TK1 and temporarily stored. The water to be treated in the tank TK1 is fed to the primary pure water device 61 by a pump P2.

The primary pure water device 61 removes organic substances, an ion component, and dissolved gas from the pretreated water to produce primary pure water. The primary pure water device 61 includes the pump P2, the pure water production device 200 of the above-described embodiment, an electrodeionizer (EDI) 611, an ultraviolet oxidation device (TOC-UV) 612, and a non-regenerative type ion exchange resin device (primary/polisher) 613 in this order. Note that the primary pure water device 61 may include any of the pure water production device 300 of the above-described embodiment or the pure water production devices of the modifications thereof, instead of the pure water production device 200.

In the primary pure water device 61, a hardness component, carbonic acid, and boron in the pretreated water are first removed in the pure water production device 200.

Thereafter, the water to be treated is fed to the electrodeionizer (EDI) 611. The electrodeionizer 611 has, for example, an anion exchange membrane and a cation exchange membrane alternately arranged between a positive electrode and a negative electrode, and alternately has a desalination chamber and a concentration chamber into which concentrated water including a removed ion component flows, with the desalination chamber and the concentration chamber partitioned by the anion exchange membrane and the cation exchange membrane. Then, the electrodeionizer includes a mixture of an anion exchange resin and a cation exchange resin filling the desalination chamber, and an electrode for applying a DC voltage.

In the electrodeionizer 611, for example, the water to be treated is fed in parallel to the desalination chamber and the concentration chamber, and the mixture of the anion exchange resin and the cation exchange resin in the desalination chamber adsorbs the ion component in the water to be treated. The adsorbed ion component is transferred to the concentration chamber by the action of the direct current, and the concentrated water in the concentration chamber is discharged to the outside of the system.

The electrodeionizer 611 can continuously remove the ion component without using any chemicals such as an acid or an alkali to regenerate the ion exchange resins at all. Therefore, it is possible to realize an improvement of safety in production of ultra-pure water, a reduction in production costs, a reduction in size of the device, and the like, leading to an improvement of production efficiency.

The desalinated water generated in the electrodeionizer 611 is then fed to the ultraviolet oxidation device 612. The ultraviolet oxidation device 612 has, for example, an ultraviolet lamp capable of irradiation with ultraviolet light having a wavelength around 185 nm, and the water to be treated is irradiated with ultraviolet light from the ultraviolet lamp to oxidatively decompose a total organic carbon component (TOC) in the water to be treated. As the ultraviolet lamp used in the ultraviolet oxidation device 612, a lamp that generates ultraviolet light having a wavelength of around 185 nm can be used. A low-pressure mercury lamp that emits ultraviolet light having a wavelength of around 254 nm together with ultraviolet light having a wavelength of around 185 nm may be used as the ultraviolet lamp. Water is decomposed by ultraviolet light emitted from the ultraviolet oxidation device 612 to generate OH radicals, and the OH radicals oxidatively decompose organic substances in the water to be treated into organic acids. The ultraviolet irradiation amount in the ultraviolet oxidation device 612 of the primary pure water device 61 can be appropriately changed depending on the water quality of the water to be treated.

Treated water of the ultraviolet oxidation device 612 is treated with the non-regenerative type ion exchange resin device (primary/polisher) 613. The non-regenerative type ion exchange resin device 613 mainly removes an ion component such as a trace organic acid generated through decomposition of an organic substance with the ultraviolet oxidation device 612.

The primary pure water obtained in this manner has, for example, a resistivity of 18 MΩ·cm or more and a TOC concentration of 10 μgC/L or less.

The ultra-pure water production system of the present embodiment includes a primary pure water tank TK2 that stores primary pure water, a pump P3, and the secondary pure water device 62 in this order as subsequent stages of the primary pure water device 61. The primary pure water produced by the primary pure water device is temporarily stored in the primary pure water tank TK2, and then sent to the secondary pure water device 62 by the pump P3. The secondary pure water device 62 includes an ultraviolet oxidation device (TOC-UV) 621, a non-regenerating polisher (polisher) 622, a membrane degassing device (MDG) 623, and an ultrafiltration device (UF) 624.

The configuration of the ultraviolet oxidation device 621 in the secondary pure water device 62 is the same as that of the ultraviolet oxidation device 612 in the primary pure water device 61. The non-regenerating polisher 622 is a mixed bed type ion exchange resin device configured by filling a container such as a cylinder with a mixture of a strongly acidic cation exchange resin and a strongly basic anion exchange resin. In addition, the non-regenerating polisher 622 is replaced with another one without regenerating the ion exchange resin in the container when the ion exchange performance decreases. The non-regenerating polisher 622 adsorbs and removes the ion component generated from an organic substance decomposed by the ultraviolet oxidation device 621.

The membrane degassing device 623 removes dissolved gas through a degassing membrane. The membrane degassing device 623 removes a small amount of dissolved oxygen in the primary pure water to reduce the dissolved oxygen concentration to, for example, about 1 μg/L or less. The ultrafiltration membrane device 624 performs a filtration treatment using an ultrafiltration membrane to remove a fine particle component and a trace eluted substance from an ion exchange resin on the upstream side, thereby reducing the number of fine particles of 0.05 μm or more to about 250 Pcs./L or less, for example.

Since an excellent carbonic acid removal ratio can be achieved in the pure water production device 200 in the ultra-pure water production system 6 of the present embodiment, a hardness removal mechanism and a degassing device for removing carbonic acid on the preceding stage side can thus be omitted. In addition, since a hardness removal mechanism and a degassing device can be omitted, and the treatment load on the pure water production device 200 is also reduced, chemical usage can be reduced, and the device can be simplified. As a result, pure water can be efficiently produced at a low cost. Further, the number of water feed pumps and output can be reduced by setting the feed water pressure in the reverse osmosis membrane treatment steps in the three stages in the pure water production device 200 to an ultra-low pressure, leading to further simplification of the device, reduction in pure water production costs, and improvement of production efficiency.

Incidentally, in each of the above-described embodiments, the water quality of raw water, pretreated water, pure water, or ultra-pure water can be measured by the following method or device.

pH: electrode method

Boron concentration: inductively coupled plasma (ICP) emission spectroscopy or inductively coupled plasma mass spectrometry (ICP-MS) method

Hardness component: ICP-MS method

Dissolved carbon dioxide gas (in terms of calcium carbonate): Sievers M9e manufactured by SUEZ WTS Analytical Instruments, Inc.

Silica (Si): atomic absorption spectroscopy/absorption spectrophotometry

Chlorine (in terms of Cl): diethyl-p-phenylenediamine (DPD) method

Electric conductivity: electric conductivity meter (HE-960CW manufactured by HORIBA, Ltd.)

Resistivity (specific resistance): resistivity meter (HE-960RW manufactured by HORIBA, Ltd.)

Total organic carbon (TOC) concentration: TOC analyzer (for non-ultrapure water: Sievers M9e manufactured by SUEZ WTS Analytical Instruments, Inc.; for ultra-pure water: Anatel A-1000XP manufactured by Beckman Coulter, Inc.)

Number of fine particles of 0.05 μm or more: particle counter (UDI-50 manufactured by Particle Measuring Systems, Inc.)

### EXAMPLES

Next, examples will be described. The present invention is not limited to the following examples.

### Example 1

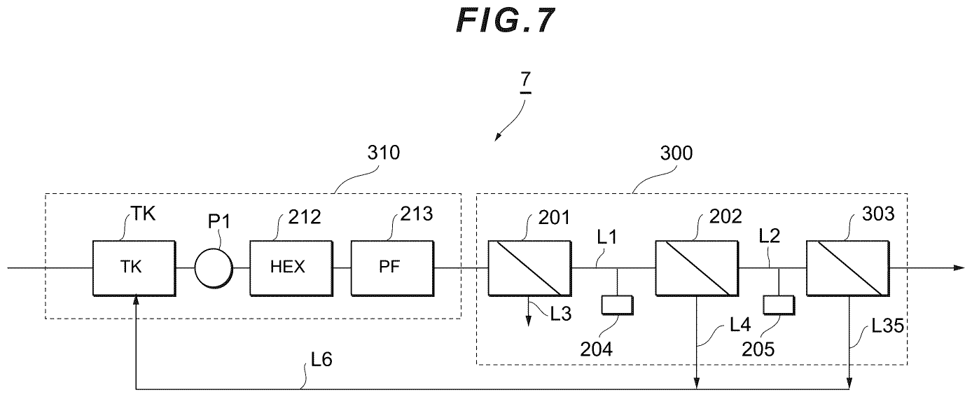

Pure water was produced using a pure water production system 7 illustrated in FIG. 7. The pure water production system 7 illustrated in FIG. 7 is formed by combining the pretreatment device 310 and the pure water production device 300 illustrated in FIG. 5. Atsugi city water was subjected to an activated carbon treatment and subsequently fed to the pretreatment device 310. Pretreated water W1 (raw water with pH=7.2, a boron concentration of 150 ppb, and a carbonic acid concentration of 30 ppm) generated through the treatment in the pretreatment device 310 was subjected to reverse osmosis membrane treatments with reverse osmosis membrane devices 201, 202, and 303 in sequence. An aqueous sodium hydroxide solution was added to the feed water of the reverse osmosis membrane device 202 by an alkali adjustment mechanism 204 so that the pH of the feed water became 9.5. Concentrated water of the reverse osmosis membrane devices 202 and 303 was circulated to a tank TK.

### Example 2

Pure water was produced using the pure water production system 7 illustrated in FIG. 7. Pretreated water (raw water with pH=7.2, a boron concentration of 50 ppb, and a carbonic acid concentration of 15 ppm) was produced by the pretreatment device 310, and the obtained pretreated water was subjected to reverse osmosis membrane treatments with the reverse osmosis membrane devices 201, 202, and 303 in sequence. An aqueous sodium hydroxide solution was added to the feed water of the reverse osmosis membrane device 202 by the alkali adjustment mechanism 204 so that the pH of the feed water became 9.5. Concentrated water of the reverse osmosis membrane devices 202 and 303 was circulated to the tank TK.

### Example 3

Pretreated water W1 was obtained in the same manner as in Example 1, and the pretreated water W1 was subjected to reverse osmosis membrane treatments with the reverse osmosis membrane devices 201, 202, and 303 in sequence. An aqueous sodium hydroxide solution was added to the feed water of the reverse osmosis membrane device 202 by the alkali adjustment mechanism 204 so that the pH of the feed water became 9.0. An aqueous sulfamic acid solution was added to the feed water of the reverse osmosis membrane device 303 so that the pH of the feed water became 6.5. Concentrated water of the reverse osmosis membrane devices 202 and 303 was circulated to the tank TK.

### Comparative Example 1

Pretreated water W1 was obtained in the same manner as in Example 1, and the pretreated water W1 was subjected to reverse osmosis membrane treatments with two stages of reverse osmosis membrane devices (corresponding to the reverse osmosis membrane devices 201 and 202 in FIG. 7) in sequence. An aqueous sodium hydroxide solution was added to the feed water of the reverse osmosis membrane device of the second stage so that the pH of the feed water became 9.5. Concentrated water of the reverse osmosis membrane device of the second stage was circulated to the tank TK in the same manner as in Example 1.

### Comparative Example 2

Pretreated water W1 was obtained in the same manner as in Example 1, and the pretreated water W1 was subjected to reverse osmosis membrane treatments with three stages of reverse osmosis membrane devices (corresponding to the reverse osmosis membrane devices 201, 202, and 303 in FIG. 7) in sequence. Sulfuric acid was added to the feed water of the reverse osmosis membrane device of the first stage so that the pH of the feed water became 6.0. In addition, an aqueous sodium hydroxide solution was added to the feed water of the reverse osmosis membrane device of the second stage so that the pH of the feed water became 9.0. An aqueous sulfamic acid solution was added to the feed water of the reverse osmosis membrane device of the third stage so that the pH of the feed water became 4.7. Concentrated water of the reverse osmosis membrane devices of the second and third stages was circulated to the tank TK in the same manner as in Example 1.

### Comparative Example 3

Pretreated water W1 was obtained in the same manner as in Example 1, and an acid was added to the pretreated water W1, followed by a treatment with a degassing tower (not shown) to obtain degassed water. The degassed water as raw water was subjected to reverse osmosis membrane treatments with three stages of reverse osmosis membrane devices (corresponding to the reverse osmosis membrane devices 201, 202, and 303 in FIG. 7) in sequence. An aqueous sodium hydroxide solution was added to the feed water of the reverse osmosis membrane device of the second stage so that the pH of the feed water became 9.0. In addition, sulfuric acid was added to the feed water of the reverse osmosis membrane device of the third stage so that the pH of the feed water became 4.7. Concentrated water of the reverse osmosis membrane devices of the second and third stages was circulated to the tank TK in the same manner as in Example 1.

In the Examples and the Comparative Examples described above, the discharge pressure of the pump P1 was set to 1.6 MPa, and TBW-HR (manufactured by Toray Industries, Inc.), which was an ultra-low pressure type reverse osmosis membrane, was used as the reverse osmosis membrane device.

### Comparative Example 4

Pretreated water W1 was obtained in the same manner as in Example 1, and the pretreated water W1 was subjected to a reverse osmosis membrane treatment using a high pressure type reverse osmosis membrane device. In the Comparative Example, the discharge pressure of the pump P1 was set to 1.6 MPa, and TM820K-400 (manufactured by Toray Industries, Inc.), which was a high pressure type reverse osmosis membrane, was used as the reverse osmosis membrane device.

The water quality of the pretreated water, the water quality of the feed water of the reverse osmosis membrane device 202 (the reverse osmosis membrane device of the second stage), the water quality of the feed water of the reverse osmosis membrane device 303 (the reverse osmosis membrane device of the third stage), and the water quality of the treated water (water quality of permeate water of the reverse osmosis membrane device of the final stage) in each of the Examples and the Comparative Examples were measured. Results are shown in Table 1. In addition, the removal ratio of each component and the total usage of the chemicals (sodium hydroxide, sulfamic acid, and sulfuric acid) in each of the Examples and the Comparative Examples were measured. The usage of the chemicals was calculated with the amount (g) used in Example 1 taken as 1. Note that since the usage of the chemicals largely fluctuates depending on operation conditions, the usage of the chemicals is shown as an approximate calculation based on a result from operation for 100 days. The results are shown in Table 2. In Tables 1 and 2, “DG” means a degassing tower, “RO2” means the reverse osmosis membrane device of the second stage (corresponding to the reverse osmosis membrane device 202 in FIG. 7), and “RO3” means the reverse osmosis membrane device of the third stage (corresponding to the reverse osmosis membrane device 303 in FIG. 7).

In the Examples and the Comparative Examples, the water quality was measured by the following device or method.

pH: HP-200 manufactured by HORIBA, Ltd.

Boron concentration: inductively coupled plasma (ICP) emission spectroscopy

Carbonic acid concentration: Sievers M9e manufactured by SUEZ WTS Analytical Instruments, Inc.

TABLE 1

| | | | | CARBONIC | ELECTRIC | |
|---|---|---|---|---|---|---|
| | | | BORON | ACID | CONDUCTIVITY | RESISTIVITY |
| | WATER QUALITY | pH | (μg/L) | (mg/L) | (μS/cm) | (MΩ · cm) |
| EXAMPLE 1 | PRETREATED WATER | 7.2 | 150 | 30 | 175 | — |
| | RO2 FEED WATER | 9.5 | 105 | 8 | 35 | — |
| | (NaOH) | | | | | |
| | RO3 FEED WATER | 9.5 | 21 | 0.16 | 16 | — |
| | TREATED WATER | 9.5 | 11 | 0.04 | 6.5 | — |
| EXAMPLE 2 | PRETREATED WATER | 7.2 | 50 | 15 | 155 | — |
| | RO2 FEED WATER | 9.5 | 35 | 4 | 30 | — |
| | (NaOH) | | | | | |
| | RO3 FEED WATER | 9.5 | 7 | 0.08 | 12 | — |
| | TREATED WATER | 9.5 | 4 | 0.02 | 4.7 | — |
| EXAMPLE 3 | PRETREATED WATER | 7.2 | 150 | 30 | 175 | — |
| | RO2 FEED WATER | 9.0 | 105 | 8 | 35 | — |
| | (NaOH) | | | | | |
| | RO3 FEED WATER | 6.5 | 30 | 0.4 | 12 | — |
| | (SULFAMIC ACID) | | | | | |
| | TREATED WATER | 7.3 | 20 | 0.4 | 0.3 | 3.3 |
| COMPARATIVE | PRETREATED WATER | 7.2 | 150 | 30 | 175 | — |
| EXAMPLE 1 | RO2 FEED WATER | 9.5 | 105 | 1.5 | 25 | — |
| | (NaOH) | | | | | |
| | TREATED WATER | 9.5 | 35 | 0.4 | 12 | — |
| COMPARATIVE | PRETREATED WATER | 7.2 | 150 | 30 | 175 | — |
| EXAMPLE 2 | RO1 FEED WATER | 6.0 | 149 | 30 | 140 | |
| | (SULFURIC ACID) | | | | | |
| | RO2 FEED WATER | 9.0 | 105 | 20 | 11 | — |
| | (NaOH) | | | | | |
| | RO3 FEED WATER | 4.7 | 30 | 1 | 4 | — |
| | (SULFAMIC ACID) | | | | | |
| | TREATED WATER | 6.5 | 26 | 0.9 | 0.25 | 4.0 |
| COMPARATIVE | PRETREATED WATER | 6.0 | 150 | 30 | 175 | — |
| EXAMPLE 3 | DEGASSED WATER | 7.2 | 150 | 0.5 | 160 | |
| | RO2 FEED WATER | 9.0 | 105 | 0.3 | 35 | — |
| | (NaOH) | | | | | |
| | RO3 FEED WATER | 4.7 | 30 | 0.015 | 16 | — |
| | (SULFAMIC ACID) | | | | | |
| | TREATED WATER | 6.5 | 26 | 0.01 | 0.125 | 8.0 |
| COMPARATIVE | PRETREATED WATER | 7.2 | 150 | 30 | 175 | — |
| EXAMPLE 4 | TREATED WATER | 6.5 | 45 | 1.5 | 5 | — |

TABLE 2

| | | | | COMPARATIVE | | | COMPARATIVE | | | | COMPARATIVE | | | |
|---|---|---|---|---|---|---|---|---|---|---|---|---|---|---|
| | EXAMPLE 1 | | | EXAMPLE 1 | | | EXAMPLE 2 | | | | EXAMPLE 3 | | | |
| | RO2 | RO3 | TOTAL | RO2 | RO3 | TOTAL | RO1 | RO2 | RO3 | TOTAL | DG | RO2 | RO3 | TOTAL |
| CHEMICAL | 1 | — | 1 | 1 | — | 1 | 95 | 1 | 1 | 97 | 95 | 1 | 1 | 97 |
| USAGE | | | | | | | | | | | | | | |

As shown in Tables 1 and 2, pure water with a sufficient decrease in boron concentration and appropriate water quality was obtained in the pure water production methods of Examples 1 to 3. In the method of Comparative Example 1, since only two stages of reverse osmosis membranes were used, a sufficient reduction in the boron concentration was not realized. In the method of Comparative Example 2, pure water with high water quality was obtained, but the electric conductivity was too low, indicating excessive water quality, and the chemical usage was large. In addition, since no degassing treatment was performed in the preceding stage in the method of Comparative Example 2, the carbonic acid concentration of the treated water was also slightly high. Pure water with high water quality could also be obtained in the method of Comparative Example 3, but the electric conductivity was too low, indicating excessive water quality. In addition, since a treatment with the degassing tower was performed in the preceding stage in the method of Comparative Example 3, problems of an increase in the chemical usage and an increase in the size of the device arose. In the method of Comparative Example 4, a high pressure type reverse osmosis membrane was used, and the power consumption therein was equal to that in Example 1; however, a sufficient reduction in the boron concentration was not realized.

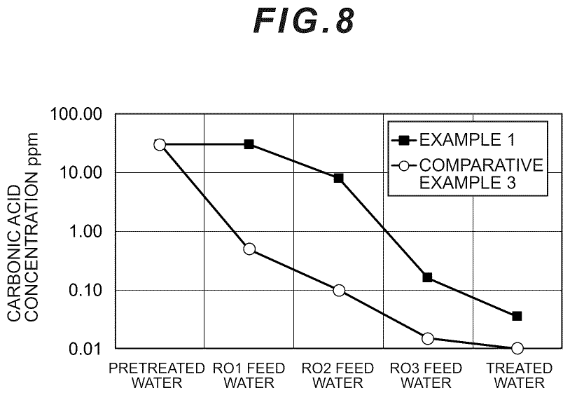

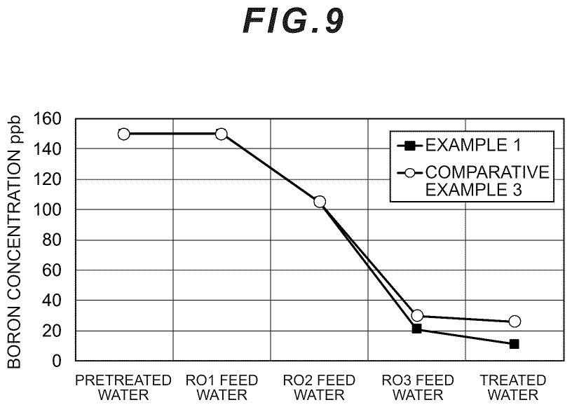

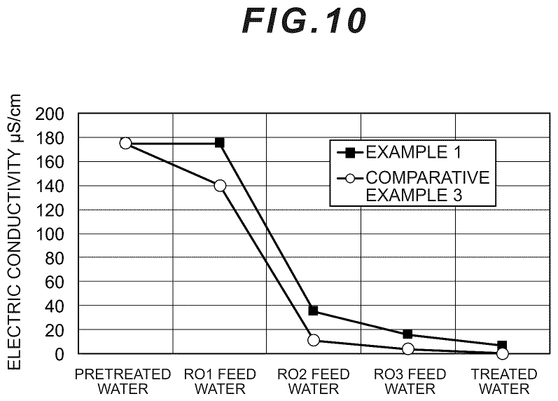

In addition, carbonic acid concentrations, boron concentrations, and electric conductivities of the pretreated water, the feed water of each of the reverse osmosis membrane devices of the respective stages, and the treated water in each of Example 1 and Comparative Example 3 are shown in FIGS. 8 to 10. FIG. 8 represents the carbonic acid concentrations in logarithm, FIG. 9 represents boron concentrations, and FIG. 10 represents electric conductivities. In FIGS. 8 to 10, “RO1” means the reverse osmosis membrane device of the first stage.

As shown in FIG. 8, in the method of Example 1, carbonic acid was removed in the reverse osmosis membrane devices of the first stage and the second stage. In contrast, it has been found that in the method of Comparative Example 3, carbonic acid was removed in the degassing tower, and the water to be treated (degassed water) from which carbonic acid had been removed was fed to the reverse osmosis membrane device of the first stage, thereby obtaining treated water having a high electric conductivity (electric conductivity: 0.125 μS/cm).

In addition, as shown in FIG. 9, in the method of Example 1, most of boron was removed in the reverse osmosis membrane device of the second stage, and part of boron was removed in the reverse osmosis membrane device of the third stage. In contrast, in the method of Comparative Example 3, boron was almost completely removed in the reverse osmosis membrane of the second stage.

Further, as shown in FIG. 10, in the method of Example 1, conductive components (such as an ion component) were almost completely removed through the reverse osmosis membrane devices of the first to third stages. In contrast, in the method of Comparative Example 3, conductive components (such as an ion component) were almost completely removed in the degassing tower and the reverse osmosis membrane device of the first stage.

From the above, it has been found that although the method of Example 1 and the method of Comparative Example 3 both use the three stages of the reverse osmosis membrane devices and shear some of the chemicals used, the effects provided by the reverse osmosis membrane devices are different.

1. A pure water production method of treating raw water with at least three stages of ultra-low pressure type reverse osmosis membrane devices to remove boron in the raw water, the pure water production method comprising:
a step of treating the raw water with a reverse osmosis membrane device of a first stage to obtain first permeate water;
a step of adjusting the first permeate water to be alkaline to obtain alkaline water to be treated;
a step of treating the alkaline water to be treated with a reverse osmosis membrane device of a second stage to obtain second permeate water; and
a step of treating the second permeate water with a reverse osmosis membrane device of a third stage to obtain pure water having a boron concentration of 3 μg/L or more and 20 μg/L or less and an electric conductivity of 0.3 μS/cm or more and 40 μS/cm or less, wherein
the three stages of the reverse osmosis membrane devices each includes a reverse osmosis membrane,
the reverse osmosis membrane is a negatively charged membrane having a skin layer including a cross-linked aromatic polyamide, and
the raw water contains 1 mg/L or more and 100 mg/L or less of carbonic acid and 150 μg/L or less of boron.

2. The pure water production method according to claim 1, wherein the alkaline water to be treated has a pH of 9.0 or higher and 10.0 or lower.

3. The pure water production method according to claim 1, further comprising
a step of adding an acid to the second permeate water to obtain second water to be treated, wherein
the second water to be treated is treated with the reverse osmosis membrane device of the third stage.

4. The pure water production method according to claim 3, wherein
the raw water contains chlorine,
sulfamic acid is added to the second permeate water in the step to obtain the second water to be treated, and
concentrated water of the reverse osmosis membrane device of the third stage is mixed with raw water and treated with the reverse osmosis membrane device of the first stage.

5. The pure water production method according to claim 3, wherein the second water to be treated has a pH of 5.5 or higher and 7.5 or lower.

6. The pure water production method according to claim 1, wherein the pure water obtained as permeate water of the reverse osmosis membrane device of the third stage is further treated with an electrodeionizer.

7. A pure water production device for removing boron having a first reverse osmosis membrane device, a second reverse osmosis membrane device, and a third reverse osmosis membrane device connected in series, the pure water production device comprising:
a raw water feed mechanism that feeds raw water containing 1 mg/L or more and 100 mg/L or less of carbonic acid and 150 μg/L or less of boron to the first reverse osmosis membrane device;
a first feed pipe that sends permeate water of the first reverse osmosis membrane device to the second reverse osmosis membrane device;
an alkali adjustment mechanism that is provided in a path of the first feed pipe and adjusts water to be treated passing through the first feed pipe to be alkaline; and
a second feed pipe that sends permeate water of the second reverse osmosis membrane device to the third reverse osmosis membrane device, wherein
the first reverse osmosis membrane device, the second reverse osmosis membrane device, and the third reverse osmosis membrane device are ultra-low pressure type reverse osmosis membrane devices,
reverse osmosis membranes included in the first reverse osmosis membrane device, the second reverse osmosis membrane device, and the third reverse osmosis membrane device are each a negatively charged membrane having a skin layer including a cross-linked aromatic polyamide, and
pure water having a boron concentration of 3 μg/L or more and 20 μg/L or less and an electric conductivity of 0.3 μS/cm or more and 40 μS/cm or less is obtained as permeate water of the third reverse osmosis membrane device.

8. The pure water production device according to claim 7, comprising an electrodeionizer in a subsequent stage of the third reverse osmosis membrane device.

9. An ultra-pure water production system, comprising a primary pure water device and a secondary pure water device in this order, wherein
the primary pure water device includes the pure water production device according to claim 7, and an electrodeionizer disposed in a subsequent stage of the pure water production device;
the secondary pure water device includes an ultraviolet oxidation device, a non-regenerating polisher, a membrane degassing device, and an ultrafiltration device in this order; and
the ultra-pure water production system produces ultra-pure water having a boron concentration of 0.1 μg/L or less.
